(19) United States
(12) Patent Application Publication
(10) Pub. No.: US 2011/0217639 A1
(43) Pub. Date: Sep. 8, 2011

(54) ELECTROPHORETIC DISPLAY FLUID

(76) Inventor: Robert A. Sprague, Saratoga, CA (US)

(21) Appl. No.: 13/038,255

(22) Filed: Mar. 1, 2011

Related U.S. Application Data
(60) Provisional application No. 61/309,796, filed on Mar. 2, 2010.

(51) Int. Cl. G03G 17/04

(52) U.S. Cl. 430/32

(57) ABSTRACT

The present invention is directed to an electrophoretic fluid which comprises a non-mobile or semi-mobile phase and charged pigment particles. The fluid has many advantages, such as increased contrast without affecting the switching speed.

This application claims the benefit of U.S. Provisional Application No. 61/309,796, filed Mar. 2, 2010, which is incorporated herein by reference in its entirety.

### FIELD OF THE INVENTION

This invention relates to an electrophoretic display fluid comprising a non-mobile or semi-mobile phase and charged pigment particles, and an electrophoretic display device utilizing such a display fluid.

### DESCRIPTION OF RELATED ART

The electrophoretic display (EPD) is a non-emissive device based on the electrophoresis phenomenon influencing charged pigment particles suspended in a colored dielectric solvent. An EPD typically comprises a pair of opposed, spaced-apart plate-like electrodes. At least one of the electrodes, typically on the viewing side, is transparent. An electrophoretic fluid composed of a colored dielectric solvent and charged pigment particles dispersed therein is enclosed between the two electrode plates. When a voltage difference is imposed between the two electrode plates, the pigment particles migrate by attraction to the plate of polarity opposite that of the pigment particles. Thus, the color showing at the transparent plate, determined by selectively charging the plates, can be either the color of the solvent or the color of the pigment particles. Reversal of plate polarity will cause the particles to migrate back to the opposite plate, thereby reversing the color.

Known techniques for an electrophoretic fluid either disperse one type of charged pigment particles in a solvent of a contrast color or disperse two types of charged pigment particles of contrast colors in a clear solvent. In the former case where white charged particles are dispersed in a dark colored solvent, the whiteness displayed by the display device is limited by absorption of light in the interstitial locations between the white charged particles and by the amount of white particles that can go into the fluid before they become too low in mobility, due to field shielding and high viscosity of the fluid. In the latter case where both black and white particles are dispersed in a clear solvent, the whiteness is also limited due to the number of white particles and the required speed at which they move.

### SUMMARY OF THE INVENTION

The present invention is directed to an electrophoretic fluid which comprises a non-mobile or semi-mobile phase and charged pigment particles.

In a first aspect of the invention, the non-mobile or semi-mobile phase comprises non-mobile or semi-mobile particles wherein the non-mobile or semi-mobile particles and the charged pigment particles are of contrasting colors and both types of the particles are dispersed in a solvent or solvent mixture.

In one embodiment, the fluid comprises only one type of the charged pigment particles. In one embodiment, the charged pigment particles and the non-mobile or semi-mobile particles are independently of any contrast colors. In one embodiment, the non-mobile or semi-mobile particles are white and the charged pigment particles are black. In one embodiment, the non-mobile or semi-mobile particles are black and the charged pigment particles are white. In one embodiment, the solvent or solvent mixture is clear. In one embodiment, the charged pigment particles are driven to the viewing side. In one embodiment, the fluid comprises two types of the charged pigment particles. In one embodiment, the two types of charged pigment particles are of contrast colors and oppositely charged. In one embodiment, the charged pigment particles are black and white, respectively. In one embodiment, the non-mobile or semi-mobile particles are of any color. In one embodiment, the non-mobile or semi-mobile particles are of red, green or blue. In one embodiment, one of the two types of the charged pigment particles is driven to the viewing side. In one embodiment, both types of the charged pigment particles are driven to be dispersed in the non-mobile or semi-mobile particles. In one embodiment, both types of the charged pigment particles are driven to the non-viewing side.

In one embodiment, the non-mobile or semi-mobile phase is formed by dispersing droplets of a non-polar solvent in a polar solvent.

In one embodiment, the non-mobile or semi-mobile phase comprises air bubbles.

In a second aspect of the invention, the non-mobile or semi-mobile phase comprises a solid porous matrix through which the charged pigment particles dispersed in a solvent or solvent mixture may move.

In one embodiment, the fluid comprises only one type of the charged pigment particles dispersed in a solvent or solvent mixture. In one embodiment, the solid porous matrix and the charged pigment particles are of contrast colors. In one embodiment, the solid porous matrix is white and the charged pigment particles are black. In one embodiment, the solid porous matrix is black and the charged pigment particles are white. In one embodiment, the fluid comprises two types of the charged pigment particles dispersed in a solvent or solvent mixture. In one embodiment, the two types of charged pigment particles are of contrast colors and oppositely charged. In one embodiment, the charged pigment particles are black and white, respectively. In one embodiment, the non-mobile or semi-mobile solid porous matrix is of any color. In one embodiment, the non-mobile or semi-mobile solid porous matrix is of red, green or blue.

In one embodiment, the surface of said charged pigment particles is coated.

In one embodiment, the surface of the non-mobile or semi-mobile particles is coated.

In one embodiment, the fluid further comprises an additive. In one embodiment, the additive is a charge controlling agent.

The electrophoretic fluid of the present invention has many advantages, such as increased contrast without affecting the switching speed.

### BRIEF DESCRIPTION OF THE DRAWINGS

FIGS. 1a, 1b & 4 depict an electrophoretic display utilizing an electrophoretic display fluid of the present invention with one type of charged pigment particles.

FIGS. 2, 3, 5 & 6 depict an electrophoretic display utilizing an electrophoretic display fluid of the present invention with two types of charged pigment particles.

### DETAILED DESCRIPTION OF THE INVENTION

The present invention is directed to an electrophoretic fluid which comprises a non-mobile or semi-mobile phase and charged pigment particles.

The non-mobile or semi-mobile phase (e.g., particles or solid porous matrix) is, by definition, far less responsive to the applied electric field than the charged pigment particles. Indeed, the non-mobile or semi-mobile phase may even be fixed in location and not move at all. The key defining part of the non-mobile or semi-mobile phase is that with an applied electric field, the charged pigment particles move through the interstitial spaces in the phase so that the image changes because the charged pigment particles are either on top of the non-mobile or semi-mobile phase (to cause the viewer to see the color of the charged pigment particles) or at the bottom (to cause the viewer to see the color of the non-mobile or semi-mobile phase).

In the first aspect of the invention, the non-mobile or semi-mobile phase comprises non-mobile or semi-mobile particles, and both the non-mobile or semi-mobile particles and the charged pigment particles are dispersed in a solvent or solvent mixture.

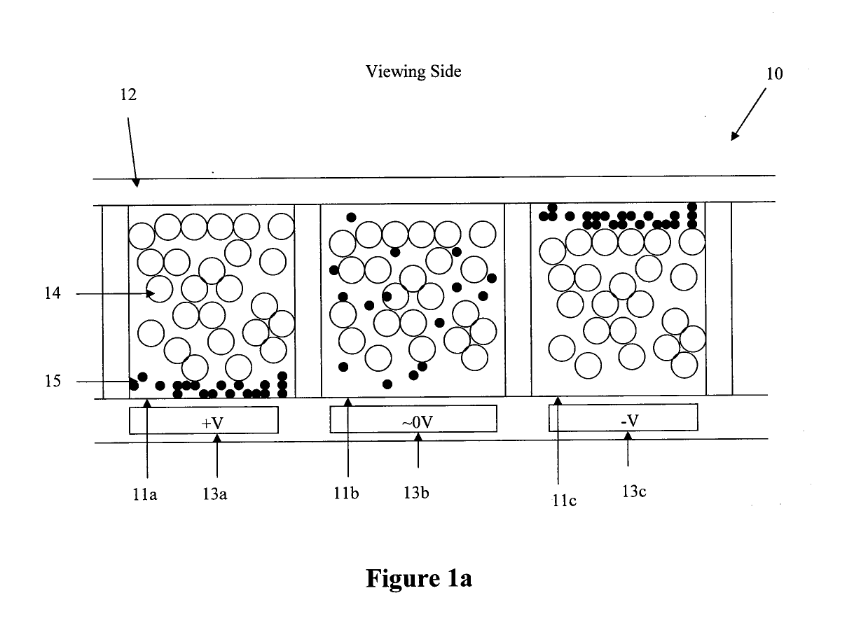

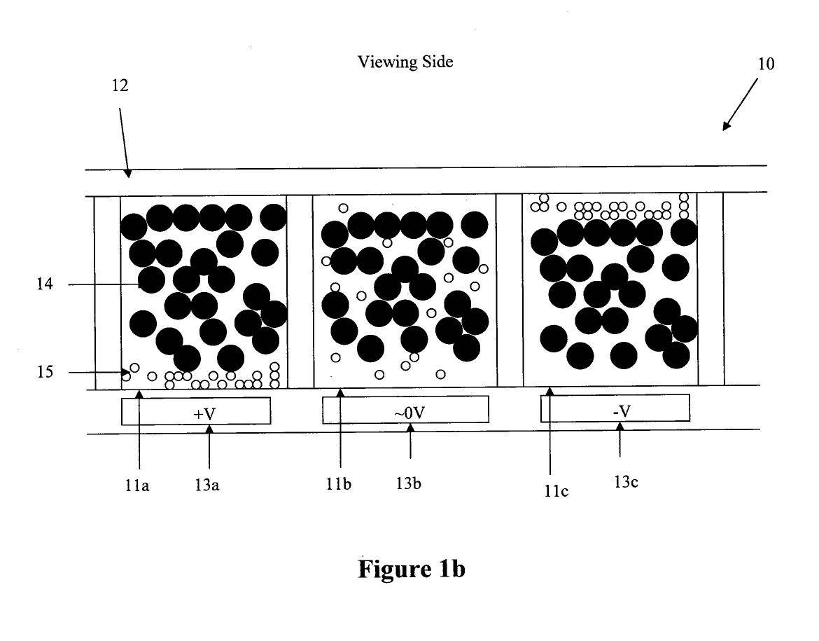

FIGS. 1a and 1b depict one embodiment of the invention in which there is only one type of charged pigment particles.

As shown in FIG. 1a, the display (10) comprises a plurality of display cells (e.g., 11a, 11b & 11c), each sandwiched between a common electrode (12) and a pixel electrode (e.g., 13a, 13b & 13c) and the display cells are filled with an electrophoretic fluid in which non-mobile or semi-mobile particles (14) and charged pigment particles (15) are dispersed in a clear solvent.

In general, the non-mobile or semi-mobile particles and the charged pigment particles are of contrast colors.

In the example shown in FIG. 1a, the non-mobile or semi-mobile particles (14) are white and the pigment particles (15) are black and negatively charged, for illustration purpose.

The term “non-mobile or semi-mobile particles”, as stated above, is intended to indicate that pigment particles are substantially stationary during operation of the display device. The non-mobile or semi-mobile particles are uniformly dispersed throughout the electrophoretic fluid in the display cells. In one embodiment, the zeta potential of the non-mobile or semi-mobile particles is less than 20, preferably less than 10, more preferably less than 5 and most preferably less than 2.

The charged black particles (15) in FIG. 1a may move towards the common electrode or a pixel electrode, depending on the charge polarity of the particles and the voltage potential difference applied to the common electrode and the pixel electrode.

In display cell (11a), when proper voltages are applied to the common electrode (12) and the pixel electrode (13a), the negatively black particles (15) would move to be near or at the pixel electrode (13a), causing the white color (i.e., the color of the non-mobile or semi-mobile particles) to be seen at the viewing side.

In display cell (11c), when proper voltages are applied to the common electrode (12) and the pixel electrode (13c), the negatively charged black particles (15) would move to be near or at the common electrode (12), causing the black color (i.e., the color of the charged pigment particles) to be seen at the viewing side.

When transitioning from white to black, the display cell (11b) may exhibit a state in which the negatively charged black particles (15) are dispersed between the white non-mobile or semi-mobile particles (14).

It is possible to have the non-mobile or semi-mobile particles in the black color and the charged pigment particles in the white color, as shown in FIG. 1b. It is also possible to have the non-mobile or semi-mobile particles in white and the charged pigment particles in a color other than black.

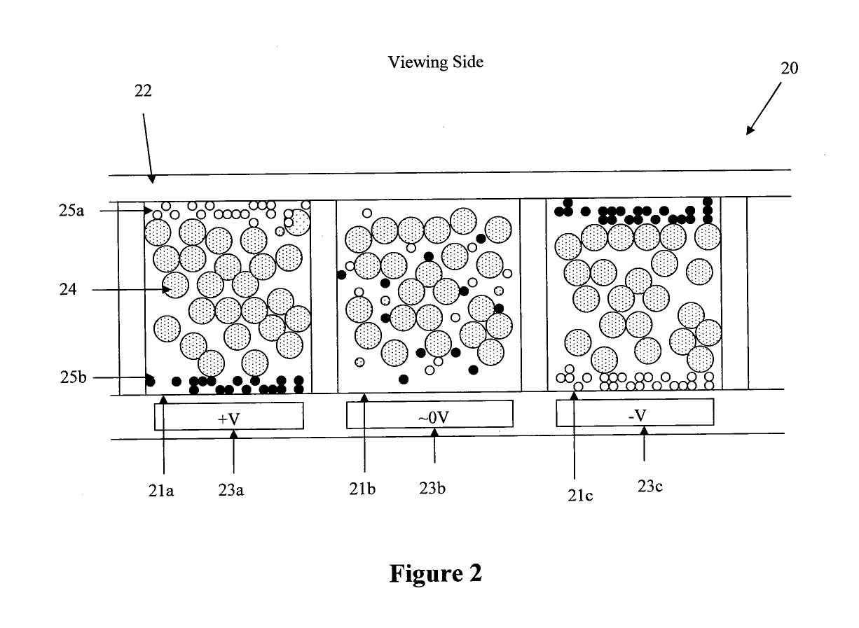

FIG. 2 depicts another embodiment of the invention in which the display fluid comprises two types of charged pigment particles. The two types of charged pigment particles carry opposite charge polarities.

As shown in the figure, a display device (20) comprises display cells (e.g., 21a, 21b & 21c), each sandwiched between a common electrode (22) and a pixel electrode (23a, 23b & 23c). It is also assumed that the non-mobile or semi-mobile particles (24) are of the red color; the positively charged particles (25a) are of the white color; and the negatively charged particles (25b) are of the black color.

In display cell (21a), when proper voltages are applied to the common electrode (22) and the pixel electrode (23a), the positively charged white particles (25a) would move to be near or at the common electrode (22) and the negatively charged black particles (25b) would move to be near or at the pixel electrode (23a), causing the white color to be seen at the viewing side.

In display cell (21c), when proper voltages are applied to the common electrode (22) and the pixel electrode (23c), the positively charged white particles (25a) would move to be near or at the pixel electrode and the negatively charged black particles (25b) would move to be near or at the common electrode (22), causing the black color to be seen at the viewing side.

In display cell (21b), when proper voltages are applied to the common electrode (22) and the pixel electrode (23b), both the positively charged white particles (25a) and the negatively charged black particles (25b) would be dispersed in the non-mobile or semi-mobile red particles (24), causing the red color of the non-mobile or semi-mobile particles (24) to be seen at the viewing side.

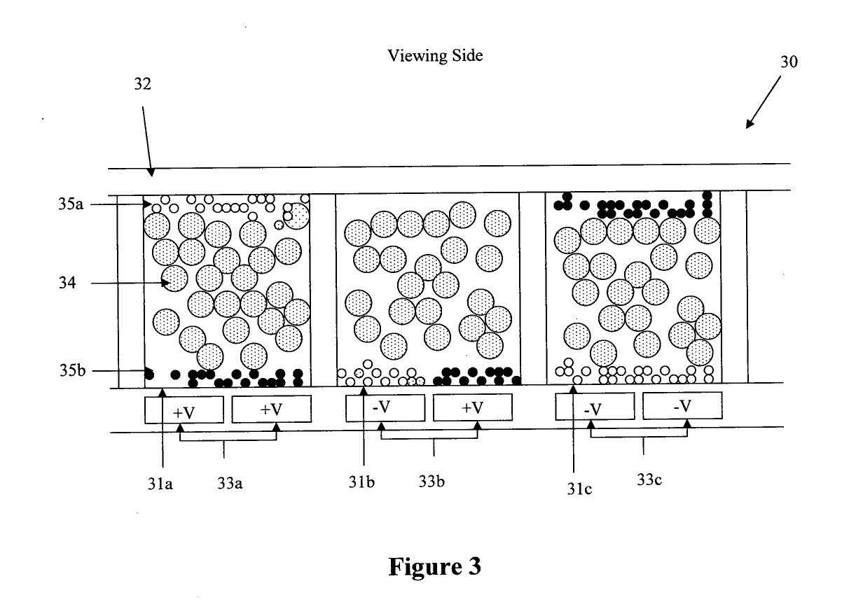

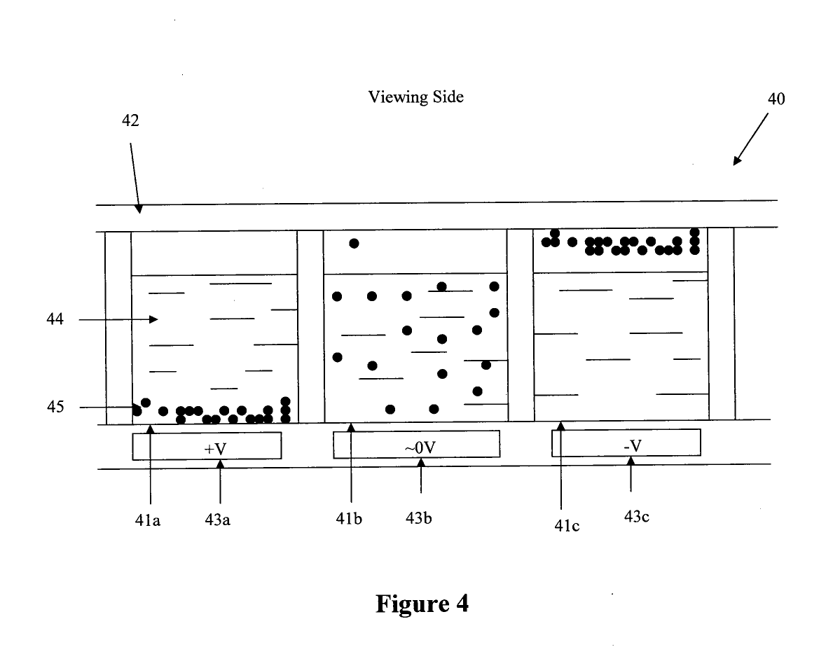

Another embodiment of the present invention with two types of charged pigment particles is shown in FIG. 3. In the example as shown, the pixel electrode of each display is divided into at least two sub-pixel electrodes. When proper voltages are applied to the common electrode (32) and the two sub-pixel electrodes, both the positively charged white particles (35a) and the negatively charged black particles (35b) would be driven to be near or at the pixel electrode area as shown in display cell 31b, thus a strong red color of the non-mobile or semi-mobile particles (34) can be viewed from the viewing side.

The presence of two types of charged pigment particles may allow display cells to display black, white, red, green and blue colors, thus leading to a multi-color display device.

The materials suitable for the non-mobile or semi-mobile particles may include, but are not limited to, organic or inorganic pigments, such as TiO₂, phthalocyanine blue, phthalocyanine green, diarylide yellow, diarylide AAOT yellow, and quinacridone, azo, rhodamine, perylene pigment series from Sun Chemical, Hansa yellow G particles from Kanto Chemical, and Carbon Lampblack from Fisher. In one embodiment, the non-mobile or semi-mobile particles are solid particles.

The solvent or solvent mixture in which the particles are dispersed preferably has a low viscosity and a dielectric constant in the range of about 2 to about 30, preferably about 2 to about 15 for high particle mobility. Examples of suitable dielectric solvent include hydrocarbons such as isopar, decahydronaphthalene (DECALIN), 5-ethylidene-2-norbornene, fatty oils, paraffin oil; aromatic hydrocarbons such as toluene, xylene, phenylxylylethane, dodecylbenzene and alkylnaphthalene; halogenated solvents such as perfluorodecalin, perfluorotoluene, perfluoroxylene, dichlorobenzotrifluoride, 3,4,5-trichl orobenzotri fluoride, chloropentafluoro-benzene, dichiorononane, pentachlorobenzene; and perfluorinated solvents such as FC-43, FC-70 and FC-5060 from 3M Company, St. Paul Minn., low molecular weight halogen containing polymers such as poly(perfluoropropylene oxide) from TCI America, Portland, Oreg., poly(chlorotrifluoroethylene) such as Halocarbon Oils from Halocarbon Product Corp., River Edge, N.J., perfluoropolyalkylether such as Galden from Ausimont or Krytox Oils and Greases K-Fluid Series from DuPont, Del. The solvent or solvent mixture may be colored by a dye or pigment.

In a further embodiment of the present invention, the non-mobile or semi-mobile phase in the display fluid may be formed by dispersing droplets of a non-polar solvent in a polar solvent. A matrix of such droplets is called a “reverse emulsion” and is described in detail in US Patent Publication No. 2010/0033802 by Roh. The non-polar solvents may include C₁₋₃₀ alkanes, C₂₋₃₀ alkenes, C₃₋₃₀ alkynes, C₃₋₃₀ aldehydes, C₃₋₃₀ ketones, C₂₋₃₀ ethers, C₂₋₃₀ esters, C₃₋₃₀ thioesters, terpenes, C₂₋₃₀ organosilanes and C₂₋₃₀ organosiloxanes. Such non-polar solvents may be used alone or in combination.

The polar solvent may include alcohols, amines, amides, ketones, carboxylic acids and their salts, glycols, polyethers, sulfides, sulconic acids and their salts, sulfates, phosphides, phosphites, phosphonites, phosphinites, phosphates, phosphonates, phosphinates, imides, nitriles, isonitriles, amidines, nitro compounds, nitroso compounds, sulfoxides, sulfonates, thiols, and water. Such polar solvents may be used alone or in combination.

Alternatively, air bubbles may be used to replace the pigment-based non-mobile particles.

In the second aspect of the invention, the non-mobile or semi-mobile phase comprises a solid porous matrix in which the charged pigment particles dispersed in a solvent or solvent mixture may move through, towards the common electrode or the pixel electrode.

The operation of the display device of FIG. 4 is similar to that of FIG. 1, except that the white non-mobile or semi-mobile particles in FIG. 1 are replaced with a white color solid porous matrix (44). The black charged pigment particles (45) (dispersed in a solvent or solvent mixture) are negatively charged. As shown, the display cell may display a white color (see display cell 41a) or a black color (see display cell 41c), depending on the voltages applied to the common electrode (42) or the pixel electrode (43a and 43c). Display cell (41b) is in a transition state in which the negatively charged black particles (45) are dispersed within the solid porous matrix (44).

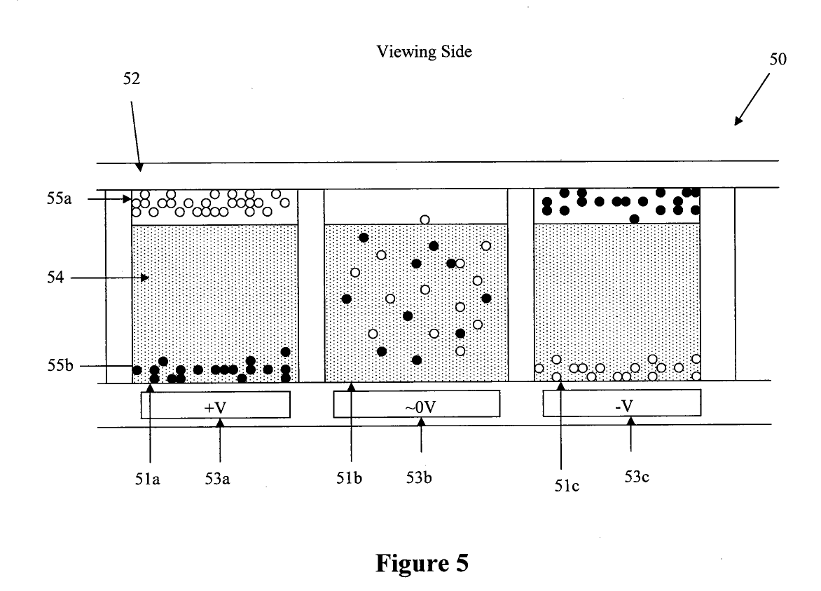

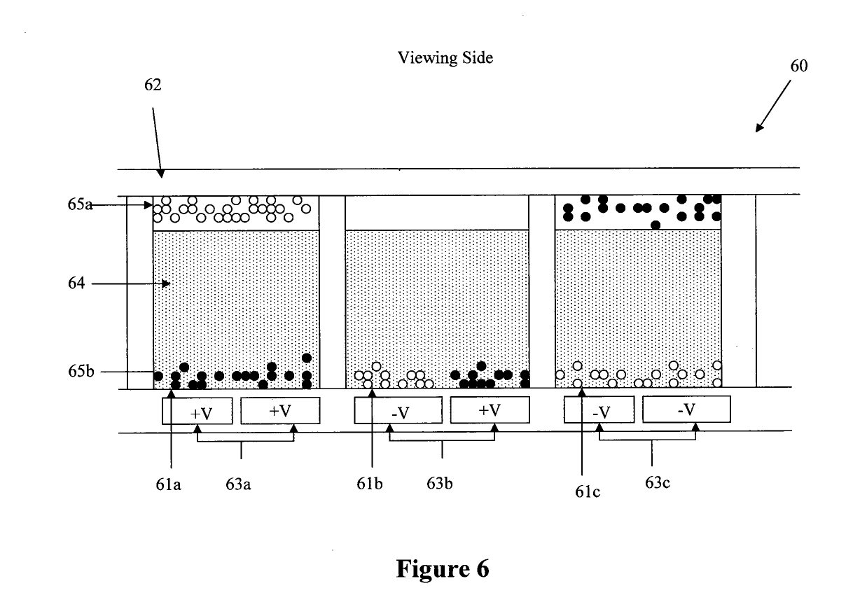

The operation of the display device of FIG. 5 is similar to that of FIG. 2, except that the red non-mobile or semi-mobile particles in FIG. 2 are replaced with a red color solid porous matrix (54). The display cell may display a white color (display cell 51a), a black color (display cell 51c) or a red color (display cell 51b).

The operation of the display device of FIG. 6 is similar to that of FIG. 3, except that the red non-mobile or semi-mobile particles in FIG. 3 are replaced with a red color solid porous matrix (64). The display cell may display a white color (display cell 61a), a black color (display cell 61c) or a red color (display cell 61b).

The solid porous matrix in FIGS. 4, 5 and 6 is prepared from either a polymeric matrix or a ceramic type filter with microchannels. In the case of a polymeric matrix, two polymeric materials are mixed together in a uniform dispersion. One of them is then cured and the other remains uncured so the uncured one can be washed out by a solvent, leaving microchannels for passage of the charged pigment particles.

In the context of the present invention, the solid porous matrix may also be a thin membrane of regenerated cellulose, cellulose ester or PVDF (polyvinyldifluoride).

The electrophoretic fluid of the present invention has many advantages. For example, in a black/white binary color system, because the white non-mobile or semi-mobile phase is present throughout the depth of each display cell, the whiteness displayed by the display device may be significantly increased. In addition, the fluid comprising the non-mobile or semi-mobile phase enables good hiding power, without having to pack the pigment particles closely together and therefore the switching speed is not affected.

The display cells referred to in the present application may be of a conventional walled or partition type, a microencapsulated type or a microcup type. In the microcup type, the electrophoretic display cells may be sealed with a top sealing layer. There may also be an adhesive layer between the electrophoretic display cells and the common electrode. The term “display cell” is intended to refer to a micro-container which is individually filled with a display fluid. Examples of “display cell” include, but are not limited to, microcups, microcapsules, micro-channels, other partition-typed display cells and equivalents thereof.

While particular forms of the invention have been illustrated and described, it will be apparent that various modifications can be made without departing from the spirit and scope of the invention. In addition, many modifications may be made to adapt a particular situation, materials, compositions, processes, process step or steps, to the objective, spirit and scope of the present invention. All such modifications are intended to be within the scope of the claims appended hereto.

What is claimed is:

1. An electrophoretic fluid comprising a non-mobile or semi-mobile phase and charged pigment particles.

2. The electrophoretic fluid of claim 1, wherein the non-mobile or semi-mobile phase comprises non-mobile or semi-mobile particles and the charged pigment particles are dispersed in a solvent or solvent mixture.

3. The electrophoretic fluid of claim 2, which comprises only one type of the charged pigment particles.

4. The electrophoretic fluid of claim 3, wherein said charged pigment particles and the non-mobile or semi-mobile particles are independently of any contrast colors.

5. The electrophoretic fluid of claim 4, wherein said non-mobile or semi-mobile particles are white and the charged pigment particles are black.

6. The electrophoretic fluid of claim 4, wherein said non-mobile or semi-mobile particles are black and the charged pigment particles are white.

7. The electrophoretic fluid of claim 2, wherein said solvent or solvent mixture is clear.

8. The electrophoretic fluid of claim 3, wherein the charged pigment particles are driven to the viewing side.

9. The electrophoretic fluid of claim 2, which comprises two types of the charged pigment particles.

10. The electrophoretic fluid of claim 9, wherein said charged pigment particles are of contrast colors and oppositely charged.

11. The electrophoretic fluid of claim 10, wherein said contrast colors are black and white.

12. The electrophoretic fluid of claim 9, wherein said non-mobile or semi-mobile particles are of any color.

13. The electrophoretic fluid of claim 12, wherein said non-mobile or semi-mobile particles are of red, green or blue.

14. The electrophoretic fluid of claim 9, wherein one of said two types of the charged pigment particles are driven to the viewing side.

15. The electrophoretic fluid of claim 9, wherein both types of the charged pigment particles are driven to be dispersed in the non-mobile or semi-mobile particles.

16. The electrophoretic fluid of claim 9, wherein both types of the charged pigment particles are driven to the non-viewing side.

17. The electrophoretic fluid of claim 1, wherein said non-mobile or semi-mobile phase is formed by dispersing droplets of a non-polar solvent in a polar solvent.

18. The electrophoretic fluid of claim 1, wherein said non-mobile or semi-mobile phase comprises air bubbles.

19. The electrophoretic fluid of claim 1, wherein said non-mobile or semi-mobile phase comprises a solid porous matrix in which the charged pigment particles dispersed in a solvent or solvent mixture are capable of moving through.

20. The electrophoretic fluid of claim 19, wherein there is only one type of the charged pigment particles.

21. The electrophoretic fluid of claim 19, wherein the solid porous matrix and the charged pigment particles are of contrast colors.

22. The electrophoretic fluid of claim 21, wherein the solid porous matrix is white and the charged pigment particles are black.

23. The electrophoretic fluid of claim 21, wherein the solid porous matrix is black and the charged pigment particles are white.

24. The electrophoretic fluid of claim 19, wherein there are two types of the charged pigment particles.

25. The electrophoretic fluid of claim 24, wherein said charged pigment particles are of contrast colors and oppositely charged.

26. The electrophoretic fluid of claim 25, wherein said contrast colors are black and white.

27. The electrophoretic fluid of claim 19, wherein said non-mobile or semi-mobile solid porous matrix is of any color.

28. The electrophoretic fluid of claim 27, wherein said non-mobile or semi-mobile solid porous matrix is of red, green or blue.

29. The electrophoretic fluid of claim 1, wherein the surface of said charged pigment particles is coated.

30. The electrophoretic fluid of claim 2, wherein the surface of the non-mobile or semi-mobile particles is coated.

31. The electrophoretic fluid of claim 1, further comprising an additive.

32. The electrophoretic fluid of claim 31, wherein said additive is a charge controlling agent.
